(19) United States
(12) Patent Application Publication
(10) Pub. No.: US 2017/0089434 A1
(43) Pub. Date: Mar. 30, 2017

(54) CONTINUOUSLY VARIABLE PLANETARY IDLER SUPPORT BEARING TO IMPROVE OR REDUCE BEARING SPEEDS AND ALLOW IDLER ASSEMBLY AXIAL MOVEMENT

(71) Applicant: Dana Limited, Maumee, OH (US)

(72) Inventors: William F. WALTZ, Toledo, OH (US); Ryan D. NELMS, Austin, TX (US); Joseph HORAK, Austin, TX (US)

(21) Appl. No.: 15/272,774

(22) Filed: Sep. 22, 2016

Related U.S. Application Data
(60) Provisional application No. 62/232,897, filed on Sep. 25, 2015.

(51) Int. Cl. F16H 15/50; F16C 25/06; F16C 19/54; F16H 57/08

(52) U.S. Cl. CPC F16H 15/503; F16H 57/08; F16C 25/06; F16C 19/541; F16H 2057/085; F16C 2361/61

(57) ABSTRACT

A continuously variable ball planetary variator comprising a main shaft, an input ring, an output ring, carriers and planets, and further comprising an improved idler support bearing capable of handling axial movement and higher differential rotational speeds between the main shaft and the idler assembly inner race. One improvement includes a continuously variable ball planetary variator comprising a main shaft, an input ring, an output ring, carriers and planets with an improved idler support bearing comprising; an idler bearing with an inner bearing race and an outer bearing race, wherein one bearing race is a split bearing race and one bearing race is a cylindrical bearing race, wherein the split bearing race has a preload between the bearings, and wherein the cylindrical bearing race allows axial movement of the idler assembly, and wherein the idler bearings comprise radial ball bearings to achieve said axial movement.

### CROSS-REFERENCE

The present application claims priority to U.S. Provisional Patent Application No. 62/232,897, filed Sep. 25, 2015, which is incorporated herein by reference in its entirety.

### BACKGROUND OF THE INVENTION

A variator is an element of a Continuously Variable Transmission (CVT) or an Infinitely Variable Transmission (IVT). A transmission having a driveline including a tilting ball variator (continuously variable planetary—CVP) allows an operator of the transmission, or a control system of the transmission to vary the drive ratio in a stepless manner. Current ball CVPs have idler assemblies with an idler support bearing that experiences axial movement and differential rotational speeds between the main shaft and the idler assembly inner race. Currently the differential bearing speeds are beyond most catalog design limits and present a challenge to bearing companies.

### SUMMARY OF THE INVENTION

Described herein is a continuously variable ball planetary variator comprising a main shaft, an input ring, an output ring, carriers and planets, and further comprising an improved idler support bearing capable of handling axial movement and higher differential rotational speeds between the main shaft and the idler assembly inner race.

Provided herein is a continuously variable ball planetary variator comprising a main shaft, an input ring assembly, an output ring assembly, a plurality of tiltable planets each comprising an axle therethrough, wherein the input ring assembly is drivingly engaged to the plurality of planets and the output ring assembly is drivingly engaged to the plurality of planets; a first carrier coupled to the main shaft through a first carrier bearing; a second carrier coupled to the main shaft through a second carrier bearing; wherein the plurality of tiltable planets are coupled to the first and second carriers through the axles; and an idler assembly supporting the tiltable planets comprising; a first idler, a second idler, an idler thrust bearing, an idler support bearing comprising; a first bearing comprising a first bearing race, a second bearing comprising a second bearing race, a plurality of bearing balls, and a third bearing race, wherein the first bearing race and second bearing race are each a standard grooved bearing race supporting the plurality of bearing balls, and the third bearing race is a cylindrical bearing race in contact with the plurality of bearing balls.

In some embodiments, the cylindrical bearing race allows axial movement of the idler assembly.

In some embodiments, the idler support bearing comprises radial ball bearings to achieve said axial movement.

In some embodiments, the standard grooved bearing races are inner bearing races and the cylindrical bearing race is an outer bearing race.

In some embodiments, the idler support bearing further comprises a capture mechanism configured to retain the two standard grooved bearing races and the bearing balls in place, relative to each other, to create an idler support bearing sub-assembly.

In some embodiments, the idler support bearing is configured to slide and or press over the main shaft for assembly, and rotate with the main shaft.

In some embodiments, the capture mechanism comprises: a retaining ring, a spacer, a shoulder, a press-fit diameter, a capture sleeve and a shoulder nut.

In some embodiments, the continuously variable ball planetary variator further comprises a spacer between the first bearing race and the second bearing race of the idler support bearing.

Provided herein is a continuously variable ball planetary variator comprising: a main shaft, an input ring assembly, an output ring assembly, a plurality of tiltable planets each comprising an axle therethrough, wherein the input ring assembly is drivingly engaged to the plurality of planets and the output ring assembly is drivingly engaged to the plurality of planets, a first carrier coupled to the main shaft through a first carrier bearing, a second carrier coupled to the main shaft through a second carrier bearing, wherein the plurality of tiltable planets are coupled to the first and second carriers through the axles; and an idler assembly supporting the tiltable planets comprising; a first idler, a second idler, an idler thrust bearing, an idler support bearing comprising; a first bearing comprising a first bearing race, a second bearing comprising a second bearing race, a plurality of bearing balls, at least one preload device acting on the first bearing race and second bearing race, and a third bearing race, wherein the first bearing race and the second bearing race are each a split bearing race each supporting the plurality of bearing balls, and the third bearing race is a cylindrical bearing race in contact with the plurality of bearing balls in both the first bearing race and the second bearing race.

In some embodiments, the cylindrical bearing race allows axial movement of the idler assembly.

In some embodiments, the idler support bearing comprises radial ball bearings to achieve said axial movement.

In some embodiments, the at least one preload device acts on the split bearing races to form at least one preloaded split bearing race, pushing the bearing balls radially into the cylindrical bearing race.

In some embodiments, the at least one preload device comprises: a wave spring, a Belleville washer, a disc spring, a coil spring, a spacer and an elastomeric material.

In some embodiments, the at least one preloaded split bearing race maintains zero radial clearance between the radial ball bearings and the cylindrical bearing race.

In some embodiments, the at least one preload device generates a force to maintain at least three-point contact between the rails of the split bearing races, the radial ball bearings and the cylindrical race.

In some embodiments, the split bearing races are the inner bearing races and the cylindrical bearing race is the outer bearing race.

In some embodiments, the idler support bearing further comprises a capture sleeve configured to retain the first bearing and second bearing with split-races, the plurality of bearing balls and the at least one preload device in place, relative to each other, to form an idler support bearing sub-assembly.

In some embodiments, the idler support bearing sub-assembly is configured to slide and or press over the main shaft for assembly, rotating with the main shaft.

In some embodiments, the continuously variable ball planetary variator further comprises a capture mechanism configured to retain the idler support bearing sub-assembly in place on the main shaft comprising; a retaining ring, a spacer, a press-fit diameter, a shoulder and a nut.

In some embodiments, a spacer utilized in the at least one preload device is configured to limit axial travel between the split-races of the first and second bearing in the event of a radial shock.

In some embodiments, the at least one preload device is positioned either; between the first bearing race and second bearing race; or axially outside of the first bearing race and or outside of the second bearing race.

Provided herein is a continuously variable ball planetary variator comprising: a main shaft, an input ring assembly, an output ring assembly, a plurality of tiltable planets each comprising an axle therethrough, wherein the input ring assembly is drivingly engaged to the plurality of planets and the output ring assembly is drivingly engaged to the plurality of planets; a first carrier coupled to the main shaft through a first carrier bearing, a second carrier coupled to the main shaft through a second carrier bearing, wherein the plurality of tiltable planets are coupled to the first and second carriers through the axles; and an idler assembly supporting the tiltable planets comprising; a first idler, a second idler, an idler thrust bearing, a first idler support bearing comprising; a first bearing comprising a first bearing race and a third bearing race, a second idler support bearing comprising; a second bearing comprising a second bearing race and a fourth bearing race, a plurality of bearing balls in the first bearing race and the second bearing race, wherein the first bearing race and the second bearing race are each a standard grooved bearing race supporting the plurality of bearing balls, wherein the third bearing race and the fourth bearing race are each a cylindrical bearing race in contact with the plurality of bearing balls in the first and second bearing races respectively, wherein both the first idler support bearing and second idler support bearing are decoupled from the main shaft and grounded between the first carrier and the second carrier to reduce the speed of the first idler support bearing and second idler support bearing.

In some embodiments, the third and fourth cylindrical bearing races allow axial movement of the idler assembly.

In some embodiments, the first and second idler support bearings comprise radial ball bearings to achieve said axial movement.

In some embodiments, the first and second standard grooved bearing races are each an inner bearing race and the third and fourth cylindrical bearing races are each an outer bearing race.

In some embodiments, the third and fourth cylindrical bearing races are grounded to the first and second carriers respectively.

In some embodiments, the first and second idler support bearings further comprises a capture sleeve configured to retain the first bearing race and the second bearing race and the plurality of bearing balls in the first bearing race and the second bearing race, relative to each other, to create an idler support bearing sub-assembly.

In some embodiments, the idler support bearing sub-assembly further comprise a capture mechanism configured to retain the first bearing race and the second bearing race, and the plurality of bearing balls in the first bearing race and the second bearing race, relative to each other within the capture sleeve.

In some embodiments, a means of grounding the first and second cylindrical bearing races to the first and second carriers comprises: a press fit, a pin, a key, a screw, a pocket in a component of one of the carriers or bearing races, a protrusion, a weld, a braze and an adhesive.

In some embodiments, the capture sleeve is configured to slide over the main shaft, but rotate independently of the main shaft.

In some embodiments, the capture mechanism comprises: a retaining ring, a spacer, a press-fit diameter, a shoulder and a nut.

In some embodiments, the continuously variable ball planetary variator further comprises: a first spacer between the first bearing race and the idler thrust bearing, and a second spacer between the second bearing race and the second idler.

Provided herein is a continuously variable ball planetary variator comprising: a main shaft, an input ring assembly, an output ring assembly, a plurality of tiltable planets each comprising an axle therethrough, wherein the input ring assembly is drivingly engaged to the plurality of planets and the output ring assembly is drivingly engaged to the plurality of planets; a first carrier coupled to the main shaft through a first carrier bearing, a second carrier coupled to the main shaft through a second carrier bearing, wherein the plurality of tiltable planets are coupled to the first and second carriers through the axles; and an idler assembly supporting the tiltable planets comprising; a first idler, a second idler, an idler thrust bearing, a first idler support bearing comprising; a first bearing race, a first preload device acting on the first bearing race and a third bearing race, a second idler support bearing comprising; a second bearing race, a second preload device acting on the second bearing race and a fourth bearing race; a plurality of bearing balls in the first bearing race and the second bearing race, wherein the first bearing race and the second bearing race are each a split-bearing race supporting the plurality of bearing balls, wherein the third bearing race and the fourth bearing race are each a cylindrical bearing race in contact with the plurality of bearing balls in the first and second bearing races respectively, wherein the first and second idler support bearings are decoupled from the main shaft and grounded between the first carrier and the second carrier to reduce the speed of the first idler support bearing and second idler support bearing.

In some embodiments, the third and fourth cylindrical bearing races allow axial movement of the idler assembly.

In some embodiments, the first and second idler support bearings comprise radial ball bearings to achieve said axial movement.

In some embodiments, the first and second bearing split races are each an inner bearing race and the third and fourth cylindrical bearing races are each an outer bearing race.

In some embodiments, the third and fourth cylindrical bearing races are grounded to the first and second carriers respectively.

In some embodiments, the means of grounding the first and second cylindrical bearing races to the first and second carriers comprises: a press fit, a pin, a key, a screw, a pocket in a component of one of the carriers or cylindrical bearing races, a protrusion, a weld, a braze and an adhesive.

In some embodiments, the first and second idler support bearings further comprise a capture sleeve configured to retain the first bearing race and the second bearing race, the plurality of bearing balls in the first bearing race and the second bearing race, and first preload device and the second preload device in place, relative to each other, to create an idler support bearing sub-assembly.

In some embodiments, the capture sleeve further comprises a capture mechanism configured to retain the first bearing race and the second bearing race, the plurality of bearing balls in the first bearing race and the second bearing race, the first preload device and the second preload device in place, relative to each other, within the capture sleeve.

In some embodiments, the capture mechanism comprises: a retaining ring, a spacer, a press-fit diameter, a shoulder and a nut.

In some embodiments, the capture sleeve is configured to slide over the main shaft, but rotate independently of the main shaft.

In some embodiments, the first and second preload devices act on the first and second bearing split-races respectively, pushing the bearing balls radially into the third and fourth cylindrical bearing races.

In some embodiments, the first and second preload devices comprise: a wave spring, a Belleville washer, a disc spring, a coil spring, a spacer and an elastomeric material.

In some embodiments, the first and second preload devices maintain zero radial clearance between the radial ball bearings of the first and second ball bearing split-races and the third and fourth cylindrical bearing race.

In some embodiments, the first and second preload devices generate forces that maintain at least three-point contact between the rails of the bearing split-races, the bearing balls and the cylindrical bearing races.

In some embodiments, the spacer of the first and second preload device is configured to limit axial travel between the split-races of the first and second bearing in the event of a radial shock.

In some embodiments, the first preload device is positioned either: between the first bearing race and the idler thrust bearing, or axially outside of the first bearing race, with the first bearing race between the first preload device and the idler thrust bearing; and wherein the second preload device is positioned either; between the second bearing race and the second idler, or axially outside of the second bearing race, with the second bearing race between the second preload device and the second idler.

Provided herein is an idler support bearing for a continuously variable ball planetary variator comprising: a first bearing comprising a first bearing race, a second bearing comprising a second bearing race, a plurality of bearing balls in the first bearing race and the second bearing race, at least one preload device acting on the first bearing race and the second bearing race and at least a third bearing race, wherein the first bearing race and the second bearing race are each a split-race supporting the plurality of bearing balls, and the at least third bearing race is a cylindrical bearing race in contact with the plurality of bearing balls, wherein the at least one preload device limits a worst case radial gap between the plurality of bearing balls supported by the first bearing split-race and the second bearing split-race and the at least third cylindrical bearing race.

In some embodiments, the at least one preload device comprises: a wave spring, a Belleville washer, a disc spring, a coil spring, a spacer and an elastomeric material.

In some embodiments, the spacer of the at least one preload device is configured to limit axial travel between the split-races of the first and second bearing in the event of a radial shock.

In some embodiments, the idler support bearing for a continuously variable ball planetary further comprises a capture sleeve configured to retain the first bearing race and the second bearing race, the plurality of bearing balls in the first bearing race and the second bearing race, and the at least one preload device in place, relative to each other, to create an idler support bearing sub-assembly.

In some embodiments, the at least one preload device is positioned either: between the first bearing race and second bearing race, or axially outside of the first bearing race and outside of the second bearing race and within the capture sleeve.

Provided herein is an idler support bearing assembly comprising a first bearing race, a second bearing race and a plurality of bearing balls, between and in contact with, the first bearing race and the second bearing race, wherein the first bearing race is a single grooved bearing race and the second bearing race is a cylindrical bearing race.

In some embodiments, the cylindrical bearing race allows axial movement of the idler assembly.

In some embodiments, the idler support bearing comprises radial ball bearings to achieve said axial movement.

In some embodiments, the standard grooved bearing race is an inner bearing race and the cylindrical bearing race is an outer bearing race.

In some embodiments, the standard grooved bearing race is configured to slide/press over the main shaft for assembly, and rotate with the main shaft during operation.

In some embodiments, idler support bearing assembly further comprises a capture mechanism configured to retain the bearing race in place on the main shaft comprising: a retaining ring, a spacer, a press-fit diameter, a shoulder and a nut.

Provided herein is a continuously variable ball planetary variator comprising a main shaft, an input ring assembly, an output ring assembly, a plurality of tiltable planets each comprising an axle therethrough, said axles further comprising a bearing at each end, wherein the input ring assembly is drivingly engaged to the plurality of planets and the output ring assembly is drivingly engaged to the plurality of planets; a first carrier coupled to the main shaft through a first carrier bearing; a second carrier coupled to the main shaft through a second carrier bearing; wherein the plurality of tiltable planets are coupled to the first and second carriers through the axles; and an idler assembly supporting the tiltable planets comprising; a first idler, a second idler, an idler thrust bearing, an idler support bearing assembly comprising; a bearing comprising a first bearing race, a plurality of bearing balls, and a second bearing race, wherein the first bearing race is a standard grooved bearing race supporting the plurality of bearing balls and the second bearing race is a cylindrical bearing race in contact with the plurality of bearing balls.

In some embodiments, the idler support bearing assembly further comprises a bearing spacer. In some embodiments the spacer is optional.

Provided herein is an idler support bearing comprising a first bearing race, at least one preload device, acting on the first bearing race, a second bearing race and a plurality of bearing balls, between and in contact with, the first bearing race and the second bearing race, wherein the first bearing race is a single split-race and the second bearing race is a cylindrical bearing race.

In some embodiments, the cylindrical bearing race allows axial movement of the idler assembly.

In some embodiments, the idler support bearing comprises radial ball bearings to achieve said axial movement.

In some embodiments, the at least one preload device acts on the split bearing race to form at least one preloaded split bearing race, pushing the bearing balls radially into the cylindrical bearing race.

In some embodiments, the at least one preload device comprises: a wave spring, a Belleville washer, a disc spring, a coil spring, a spacer and an elastomeric material.

In some embodiments, the at least one preloaded split bearing race maintains zero radial clearance between the radial ball bearings and the cylindrical bearing race.

In some embodiments, the at least one preload device generates a force to maintain at least three-point contact between the split bearing races, the radial ball bearings and the cylindrical race.

In some embodiments, the split bearing race is the inner bearing races and the cylindrical bearing race is the outer bearing race.

In some embodiments, the idler support bearing further comprises a capture sleeve configured to retain the bearing with the split-race, the plurality of bearing balls and the at least one preload device in place, relative to each other, to form an idler support bearing sub-assembly.

In some embodiments, the idler support bearing sub-assembly is configured to slide and or press over the main shaft for assembly and rotate with the main shaft.

In some embodiments, the idler support bearing further comprises a capture mechanism configured to retain the idler support bearing sub-assembly in place on the main shaft comprising a retaining ring, a spacer, a press-fit diameter, a shoulder and a nut.

In some embodiments, the spacer of the at least one preload device is configured to limit axial travel of the split-races in the event of a radial shock.

In some embodiments, the spacer of the at least one preload device and the split-bearing races are configured within a capture sleeve to limit axial travel “x” of the split-races.

In some embodiments, the at least one preload device is positioned either: on only one side of the split bearing race, or on both sides of the split bearing race.

Provided herein is a continuously variable ball planetary variator comprising a main shaft, an input ring assembly, an output ring assembly, a plurality of tiltable planets each comprising an axle therethrough, said axles further comprising a bearing at each end, wherein the input ring assembly is drivingly engaged to the plurality of planets and the output ring assembly is drivingly engaged to the plurality of planets, a first carrier coupled to the main shaft through a first carrier bearing, a second carrier coupled to the main shaft through a second carrier bearing, wherein the plurality of tiltable planets are coupled to the first and second carriers through the axles, and an idler assembly supporting the tiltable planets comprising; a first idler, a second idler, an idler thrust bearing, an idler support bearing assembly comprising; a bearing comprising a first bearing race, a plurality of bearing balls, at least one preload device acting on the first bearing race, and a second bearing race, wherein the first bearing race is a split bearing race, supporting the plurality of bearing balls, and the second bearing race is a cylindrical bearing race in contact with the plurality of bearing balls.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an illustrative arrangement of an exemplary idler assembly with two idler support bearings in contact with the main shaft, each comprising standard grooved inner bearing races and a spacer therebetween, and with both support bearings in contact with a cylindrical bearing race under the idler assembly.

FIG. 2 is an illustrative arrangement of an exemplary idler assembly with two idler support bearings in contact with the main shaft, each comprising a split-inner-race bearing and a preload therebetween, and with both support bearings in contact with a cylindrical bearing race under the idler assembly.

FIG. 3 is an alternative illustrative arrangement of the exemplary idler assembly of FIG. 1, with the two idler support bearings decoupled from the main shaft and grounded to the carriers, wherein the two idler support bearings pilot the idler assembly and each support bearing comprises a standard grooved bearing race, a spacer therebetween and each support bearing in contact with a cylindrical bearing race that is grounded to one of the carriers.

FIG. 4 is an alternative illustrative arrangement of the exemplary idler assembly of FIG. 2, with two idler support bearings decoupled from the main shaft and grounded to the carriers, wherein the two idler support bearings pilot the idler assembly and each support bearing comprises a split-inner-race bearing, a preload therebetween and each support bearing in contact with a cylindrical bearing race that is grounded to one of the carriers.

FIG. 5 is an illustrative arrangement of an idler support bearing assembly with two split race bearings to limit radial clearance with controlled spacer clearance.

FIG. 6 is an illustrative arrangement of an idler support bearing that uses only one grooved bearing race in a CVP to achieve a similar effect to one having more than one grooved bearing race.

FIG. 7 is an illustrative arrangement of an idler support bearing that uses only one preloaded split-race bearing in a CVP to achieve a similar effect to one having more than one preloaded split-race bearing.

FIG. 8 is an illustrative arrangement of an exemplary idler assembly with one idler support bearing in contact with the main shaft, comprising a standard grooved inner bearing race of FIG. 6 and an optional spacer between retaining rings, and with the support bearing in contact with a cylindrical bearing race under the idler assembly.

FIG. 9 is an illustrative arrangement of an exemplary idler assembly with one idler support bearing in contact with the main shaft, comprising a split-inner-race bearing and a preload in an optional capture sleeve between retaining rings, and the support bearing in contact with a cylindrical bearing race under the idler assembly.

### DETAILED DESCRIPTION OF THE INVENTION

The present device provides a novel means to allow the idler assembly to have axial movement while simultaneously improving the idler support bearing speed capability.

The embodiments of the disclosure and the various features and advantageous details thereof are explained more fully with reference to the non-limiting embodiments and examples that are described and/or illustrated in the accompanying drawings and detailed in the following description.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those skilled in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

A CVT tilting ball variator (CVP) is a form of variable speed traction drive based on planetary gear principles, but using balls, (spheres, or traction planets), instead of gear toothed planets. A tilting ball variator (CVP) includes a first drive ring, a second drive ring, a plurality of variator balls, a carrier, and an idler assembly, disposed between the first drive ring and the second drive ring. The ratio is shifted by simultaneously tilting the axis angle of each of the variator balls, for example, by moving a carrier, on which the plurality of variator balls are rotatably disposed. Tilting the balls changes their contact diameters and varies the speed ratio. As a result, the CVT system offers seamless and continuous transition to any ratio within its range. The system has multiple “planets” (balls) which transfer torque through multiple fluid patches. The planets are placed in a circular array around a central idler (sun) and contact separate input and output traction rings. An idler in the CVP context is not the same as when used in a gearing context. In a CVP, the idler acts as an inner race (or sun) of a multi-planet system where it is a rotatable member that supports the inward radial forces from the planets. This configuration allows input and output to be concentric and compact. The result is the ability to sweep the transmission through the entire ratio range smoothly, while in motion, under load.

Current ball CVPs have idler assemblies with an idler support bearing that experiences axial movement and differential rotational speeds between the main shaft and the idler assembly inner race.

Currently the differential bearing speeds are beyond most catalog design limits and present a challenge to bearing companies. Needle and roller bearings are the typical bearings that can allow rotational and axial movement, but they also lack the necessary speed rating for proposed designs of continuously variable ball planetary variators. Standard grooved radial ball bearings are not designed to allow axial movement and they can also lack the necessary speed rating.

Alternatively, some bearing designs propose using angular contact bearings because they can withstand higher speeds, but angular contact bearings will not allow the assembly to move axially. Angular contact bearings need to have a preload. The angular contact bearings would have to be a preloaded assembly which would also present packaging difficulties radially and axially.

Yet another option to improve the bearing speed is to reduce the idler support bearing speed by grounding (zero speed) one bearing race to remove the main shaft speed.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces which would be available at the interfaces of the contacting components and is a measure of the maximum available drive torque. Typically, friction drives generally relate to transferring power between two elements by frictional forces between the elements. For the purposes of this disclosure, it should be understood that the CVTs described here may operate in both tractive and frictional applications. As a general matter, the traction coefficient t is a function of the traction fluid properties, the normal force at the contact area, and the velocity of the traction fluid in the contact area, among other things.

For description purposes, the terms “prime mover”, “engine,” and like terms, are used herein to indicate a power source. Said power source may be fueled by energy sources comprising hydrocarbon, electrical, biomass, nuclear, solar, geothermal, hydraulic, pneumatic, and/or wind to name but a few. Although typically described in a vehicle or automotive application, one skilled in the art will recognize the broader applications for this technology and the use of alternative power sources for driving a transmission comprising this technology.

As used herein, and unless otherwise specified, the term “about or approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 30%, 25%, 20%, 15%, 10%, 9%, 8%, 7%, 6%, 5%, 4%, 3%, 2%, 1%, 0.5%, 0.1%, or 0.05% of a given value or range. In certain embodiments, the term “about” or “approximately” means within 40.0 mm, 30.0 mm, 20.0 mm, 10.0 mm 5.0 mm 1.0 mm, 0.9 mm, 0.8 mm, 0.7 mm, 0.6 mm, 0.5 mm, 0.4 mm, 0.3 mm, 0.2 mm or 0.1 mm of a given value or range. In certain embodiments, the term “about” or “approximately” means within 20 degrees, 15.0 degrees, 10.0 degrees, 9.0 degrees, 8.0 degrees, 7.0 degrees, 6.0 degrees, 5.0 degrees, 4.0 degrees, 3.0 degrees, 2.0 degrees, 1.0 degrees, 0.9 degrees, 0.8 degrees, 0.7 degrees, 0.6 degrees, 0.5 degrees, 0.4 degrees, 0.3 degrees, 0.2 degrees, 0.1 degrees, 0.05 degrees of a given value or range.

As used herein, “about” when used in reference to a velocity of the moving object or movable substrate means variation of 1%-5%, of 5%-10%, of 10%-20%, and/or of 10%-50% (as a percent of the percentage of the velocity, or as a variation of the percentage of the velocity). For example, if the percentage of the velocity is “about 20%”, the percentage may vary 5%-10% as a percent of the percentage i.e. from 19% to 21% or from 18% to 22%; alternatively the percentage may vary 5%-10% as an absolute variation of the percentage i.e. from 15% to 25% or from 10% to 30%.

In certain embodiments, the term “about” or “approximately” means within 0.01 sec., 0.02 sec, 0.03 sec., 0.04 sec., 0.05 sec., 0.06 sec., 0.07 sec., 0.08 sec. 0.09 sec. or 0.10 sec of a given valve or range. In certain embodiments, the term “about” or “approximately” means within 0.5 rpm/sec, 1.0 rpm/sec, 5.0 rpm/sec, 10.0 rpm/sec, 15.0 rpm/sec, 20.0 rpm/sec, 30 rpm/sec, 40 rpm/sec, or 50 rpm/sec of a given value or range.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

Described herein is a continuously variable ball planetary variator comprising a main shaft, an input ring, an output ring, carriers and planets, and further comprising an improved idler support bearing capable of handling axial movement and higher differential rotational speeds between the main shaft and the idler assembly inner race.

The various iterations of the device described herein pertain to devices and methods relating to allowing the idler assembly to have axial movement, improving the idler support bearings to handle the high rotational speeds of a variator, and/or isolating the idler support bearing speeds from the main shaft speeds.

Four idler support bearing solutions are described in detail herein. The first and third solutions use radial ball bearings with two standard grooved bearing races and a third race that is cylindrical to allow axial movement. The second and fourth solutions both use radial ball bearings with two preloaded split races and a third race that is cylindrical to allow axial movement and also increases the bearing's speed rating. By having a split race that is preloaded, the radial bearing has the ability to operate at higher speeds just like a low contact angle, angular contact bearing has the ability to operate at higher speeds than a pure radial bearing. The wedging effect of the contact angle on a preloaded split race increases the speed rating because the ball to race clearance is eliminated and the bearing balls are in positive contact with the inner and outer races preventing ball skidding at high speed. The wedging effect also allows the contacts to be loaded and to operate like traction contacts. The third and fourth solutions use the cylindrical race grounded to the carrier to isolate the idler support inner bearing speed from the main shaft speed and to reduce the idler support bearing speed. In this configuration, the idler assembly is still free to move axially along the grounded cylindrical race.

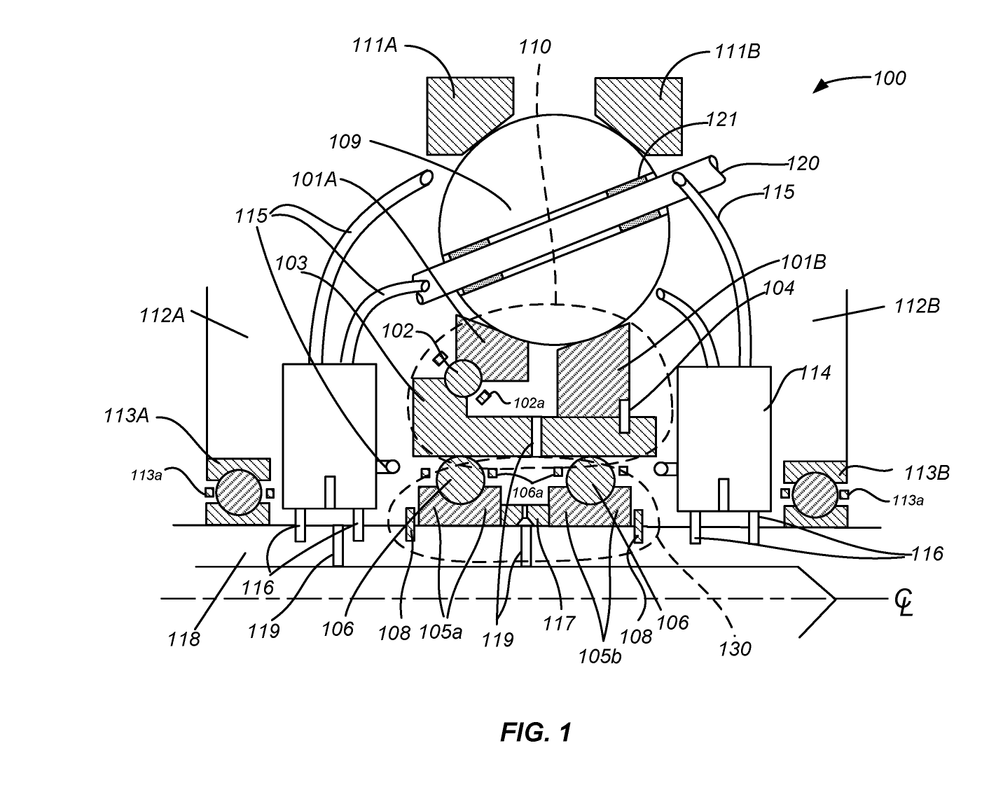

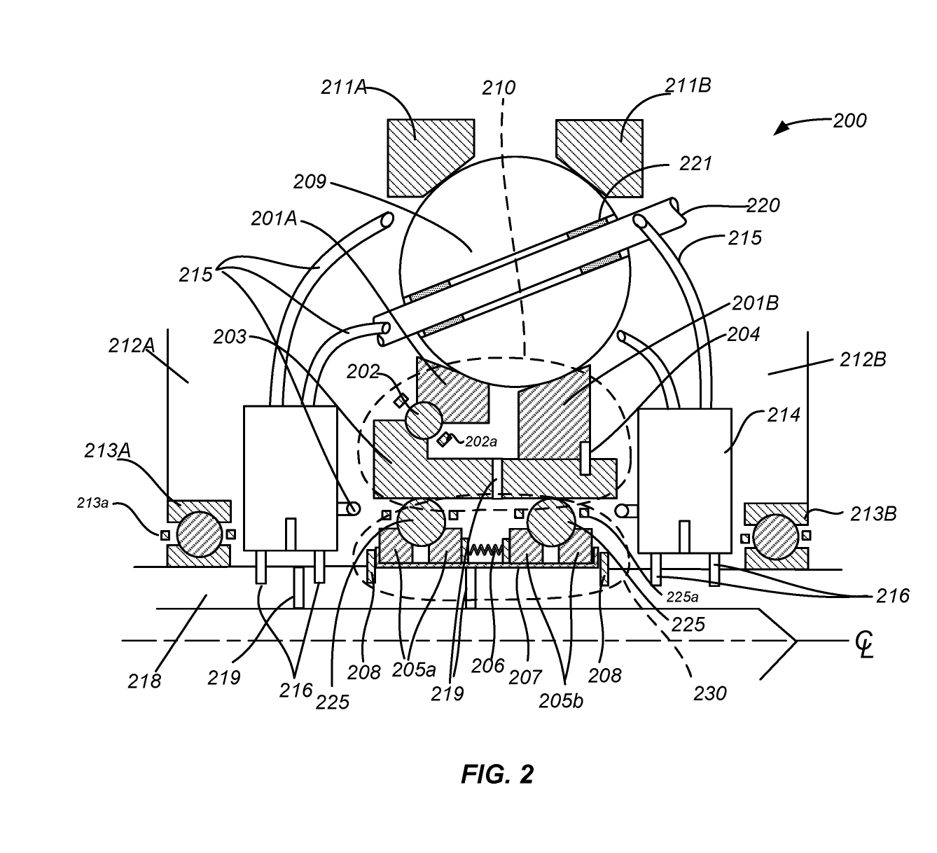

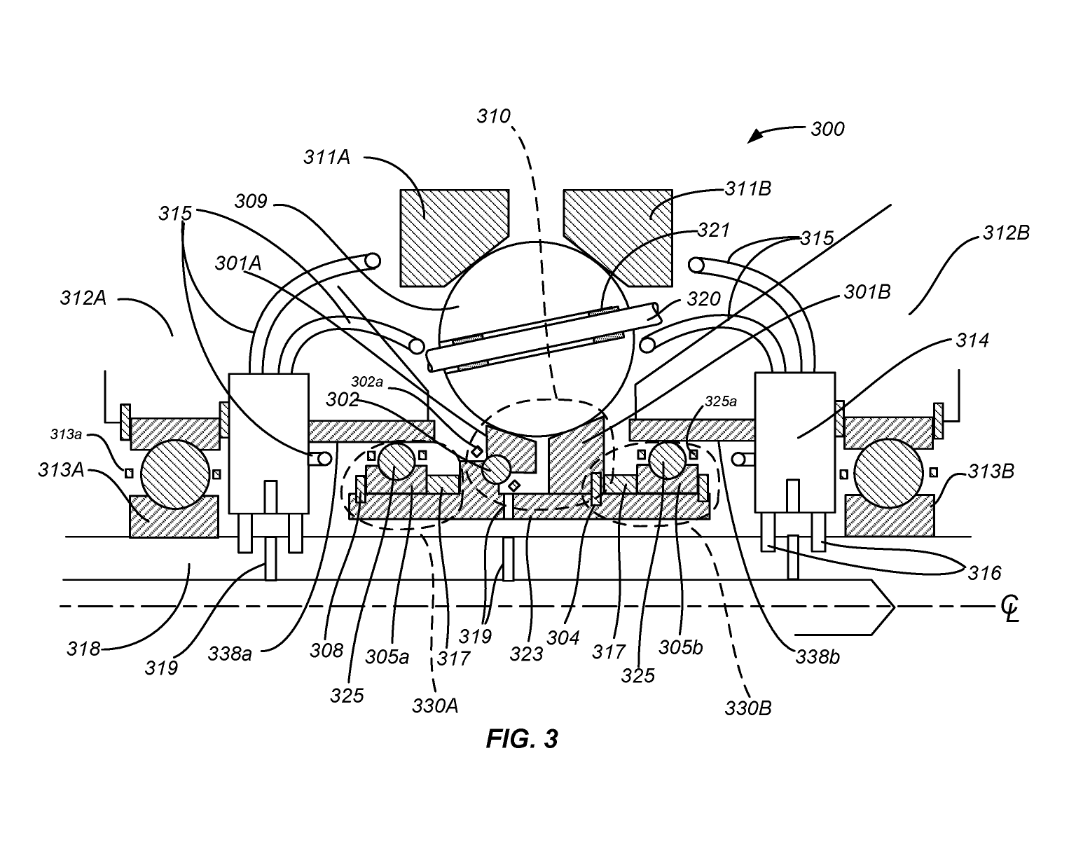

FIGS. 1, 2, 3 and 4 show the idler support outer bearing races with cylindrical races. Conversely, the inner races could be cylindrical. There are advantages to having the outer race cylindrical. The outer race will have a larger contact patch because there is one concave surface (outer race) and one convex surface (bearing ball) in contact. Because the outer race wraps around the bearing ball, there is more conformity between the outer race and the bearing ball to increase the contact size and reduce the contact stress. Conversely, with a cylindrical inner race, the contact patch will be small on the inner race and the contact stresses high because there are two convex surfaces (cylindrical inner race and bearing ball) in contact (convexity). But, with standard grooved inner races (solutions one and three), there is conformity between the inner raceway groove and the ball to increase the contact size and reduce the contact stress. If the inner races are split (solutions two and four), there are two contact patches to share the contact stress between the two split races and the ball. If the inner race was cylindrical, there would be no raceway conformity and/or no extra contact patch to share the load. If the inner race was cylindrical the inner race contact stress would be disproportionally higher than the outer race contact stress. The advantage to having the outer race cylindrical is to reduce the inner race contact stress and to distribute the contact stress more evenly between the inner and outer races.

Provided herein is a continuously variable ball planetary variator 100, as illustrated in FIG. 1, comprising a main shaft 118, an input ring assembly 111A, an output ring assembly 111B, a plurality of tiltable planets 109 each comprising an axle 120 therethrough, said axles further comprising a bearing 121 at each end, wherein the input ring assembly 111A is drivingly engaged to the plurality of planets 109 and the output ring assembly 111B is drivingly engaged to the plurality of planets 109; a first carrier 112A coupled to the main shaft 118 through a first carrier bearing 113A; a second carrier 112B coupled to the main shaft 118 through a second carrier bearing 113B; wherein the plurality of tiltable planets 109 are coupled to the first and second carriers 112A and 112B through the axles 120; and an idler assembly 110 supporting the tiltable planets 109 comprising; a first idler 101A, a second idler 101B, an idler thrust bearing 102, an idler support bearing 130 comprising; a first bearing comprising a first bearing race 105a, a second bearing comprising a second bearing race 105b, a plurality of bearing balls 106, and a third bearing race 103, wherein the first bearing race 105a and second bearing race 105b are each a standard grooved bearing race supporting the plurality of bearing balls 106, and the third bearing race 103 is a cylindrical bearing race in contact with the plurality of bearing balls 106.

In some embodiments, the cylindrical bearing race 103 allows axial movement of the idler assembly 110.

In some embodiments, the idler support bearing 130 comprises radial ball bearings 106 to achieve said axial movement.

In some embodiments, the standard grooved bearing races 105a, 105b are inner bearing races and the cylindrical bearing race 103 is an outer bearing race.

In some embodiments, the idler support bearing 130 further comprises a capture mechanism 108 configured to retain the two standard grooved bearing races 105a, 105b and the bearing balls 106 in place, relative to each other, to create an idler support bearing sub-assembly 130.

In some embodiments, the idler support bearing 130 is configured to slide and/or press over the main shaft 118 for assembly, and rotate with the main shaft 118.

In some embodiments, the capture mechanism 108 comprises: a retaining ring, a spacer 117, a shoulder, a press-fit diameter, a capture sleeve and a shoulder nut.

In some embodiments, the continuously variable ball planetary variator further comprises a spacer 117 between the first bearing race 105a and the second bearing race 105b of the idler support bearing 130.

Provided herein is a continuously variable ball planetary variator 200 comprising: a main shaft 218, an input ring assembly 211A, an output ring assembly 211B, a plurality of tiltable planets 209 each comprising an axle 220 therethrough, said axles further comprising a bearing 221 at each end, wherein the input ring assembly 211A is drivingly engaged to the plurality of planets 209 and the output ring assembly 211B is drivingly engaged to the plurality of planets 209, a first carrier 212A coupled to the main shaft 218 through a first carrier bearing 213A, a second carrier 212B coupled to the main shaft 218 through a second carrier bearing 213B, wherein the plurality of tiltable planets 209 are coupled to the first and second carriers 212A, 212B through the axles 220, and an idler assembly 210 supporting the tiltable planets comprising; a first idler 201A, a second idler 201B, an idler thrust bearing 202, an idler support bearing 230 comprising; a first bearing comprising a first bearing race 205a, a second bearing comprising a second bearing race 205b, a plurality of bearing balls 225, at least one preload device 206 acting on the first bearing race 205a and second bearing race 205b, and a third bearing race 203, wherein the first bearing race 205a and the second bearing race 205b are each a split bearing race, each supporting the plurality of bearing balls 225, and the third bearing race 203 is a cylindrical bearing race in contact with the plurality of bearing balls 225 in both the first bearing race 205a and the second bearing race 205b.

In some embodiments, the cylindrical bearing race 203 allows axial movement of the idler assembly 210.

In some embodiments, the idler support bearing 230 comprises radial ball bearings 225 to achieve said axial movement.

In some embodiments, the at least one preload device 206 acts on the split bearing races 205a, 205b to form at least one preloaded split bearing race, pushing the bearing balls 225 radially into the cylindrical bearing race 203.

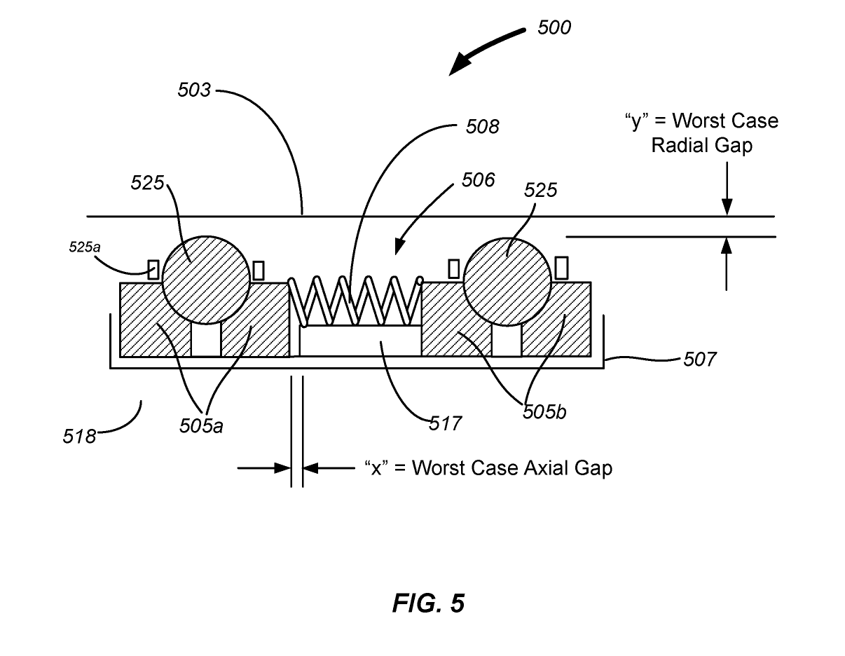

In some embodiments, the at least one preload device comprises: a wave spring, a Belleville washer, a disc spring, a coil spring (i.e.: 508), a spacer 517 (as illustrated in FIG. 5) and an elastomeric material.

In some embodiments, the at least one preloaded split bearing race maintains zero radial clearance ‘y” between the radial ball bearings 225 and the cylindrical bearing race 203.

In some embodiments, the at least one preload device 706 generates a force to maintain at least three-point contact (a, b, c) between the rails of the split bearing races 705, the radial ball bearings 725 and the cylindrical race 703, as illustrated in FIG. 7.

In some embodiments, the split bearing races 205a, 205b are the inner bearing races and the cylindrical bearing race 203 is the outer bearing race.

In some embodiments, the idler support bearing 230 further comprises a capture sleeve 207 configured to retain the first bearing and second bearing 205a, 205b with split-races, the plurality of bearing balls 225 and the at least one preload device 206 in place, relative to each other, to form an idler support bearing sub-assembly 230.

In some embodiments, the idler support bearing sub-assembly 230 is configured to slide and or press over the main shaft 218 for assembly, rotating with the main shaft 218.

In some embodiments, the continuously variable ball planetary variator 200 further comprises a capture mechanism 208 configured to retain the idler support bearing sub-assembly 230 in place on the main shaft 218 comprising; a retaining ring, a spacer 517, a press-fit diameter, a shoulder and a nut.

In some embodiments, a spacer 517, 717 utilized in the at least one preload device 506, 706 is configured to limit axial travel between the split-races of the first and or second bearing in the event of a radial shock, as illustrated in FIGS. 5 and 7.

In some embodiments, the at least one preload device 206 is positioned either; between the first bearing race 205a and second bearing race 205b; or axially outside of the first bearing race 205a and or outside of the second bearing race 205b, wherein the first bearing race and second bearing race could be touching or held apart by a spacer or shoulder.

Provided herein is a continuously variable ball planetary variator 300 comprising: a main shaft 318, an input ring assembly 311A, an output ring assembly 311B, a plurality of tiltable planets 309 each comprising an axle 320 therethrough, said axles further comprising a bearing 321 at each end, wherein the input ring assembly 311A is drivingly engaged to the plurality of planets 309 and the output ring assembly 311B is drivingly engaged to the plurality of planets 309; a first carrier 312A coupled to the main shaft 318 through a first carrier bearing 313A, a second carrier 312B coupled to the main shaft 318 through a second carrier bearing 313B, wherein the plurality of tiltable planets 309 are coupled to the first and second carriers 312A, 312B through the axles 320; and an idler assembly 310 supporting the tiltable planets 309 comprising; a first idler 301A, a second idler 301B, an idler thrust bearing 302, a first idler support bearing 330A comprising; a first bearing comprising a first bearing race 305a and a third bearing race 338a, a second idler support bearing 330B comprising; a second bearing comprising a second bearing race 305b and a fourth bearing race 338b, a plurality of bearing balls 325 in the first bearing race 305a and the second bearing race 305b, wherein the first bearing race 305a and the second bearing race 305b are each a standard grooved bearing race supporting the plurality of bearing balls 325, wherein the third bearing race 338a and the fourth bearing race 338b are each a cylindrical bearing race in contact with the plurality of bearing balls 325 in the first and second bearing races 305a, 305b respectively, wherein both the first idler support bearing 330A and second idler support bearing 330B are decoupled from the main shaft 318 and grounded between the first carrier 312A and the second carrier 312B to reduce the speed of the first idler support bearing 330A and second idler support bearing 330B.

In some embodiments, the third and fourth cylindrical bearing races 338a, 338b allow axial movement of the idler assembly 310.

In some embodiments, the first and second idler support bearings 305a, 305b comprise radial ball bearings 325 to achieve said axial movement.

In some embodiments, the first and second standard grooved bearing races 305a, 305b are each an inner bearing race and the third and fourth cylindrical bearing races 338a, 338b are each an outer bearing race.

In some embodiments, the third and fourth cylindrical bearing races 338a, 338b are grounded to the first and second carriers 312A, 312B respectively.

In some embodiments, the first and second idler support bearings 330A, 330B further comprise a capture sleeve 323 configured to retain the first bearing race 305a and the second bearing race 305b and the plurality of bearing balls 325 in the first bearing race 305a and the second bearing race 305b, relative to each other, to create an idler support bearing sub-assembly.

In some embodiments, the idler support bearing sub-assembly further comprises a capture mechanism 308 configured to retain the first bearing race 305a and the second bearing race 305b, and the plurality of bearing balls 325 in the first bearing race 305a and the second bearing race 305b, relative to each other within the capture sleeve 323.

In some embodiments, a means of grounding the first and second cylindrical bearing races 338a, 338b to the first and second carriers 312A, 312B comprises: a press fit, a pin, a key, a screw, a pocket in a component of one of the carriers or bearing races, a protrusion, a weld, a braze and an adhesive.

In some embodiments, the capture sleeve 323 is configured to slide over the main shaft 318, but rotate independently of the main shaft 318.

In some embodiments, the capture mechanism comprises: a retaining ring 308, a spacer 317, a press-fit diameter, a shoulder and a nut.

In some embodiments, the continuously variable ball planetary variator further comprises: a first spacer 317 between the first bearing race 305a and the idler thrust bearing 301A, and a second spacer 317 between the second bearing race 305b and the second idler 301B.

Provided herein is a continuously variable ball planetary variator 400 comprising: a main shaft 418, an input ring assembly 411A, an output ring assembly 411B, a plurality of tiltable planets 409 each comprising an axle 420 therethrough, said axles further comprising a bearing 421 at each end, wherein the input ring assembly 411A is drivingly engaged to the plurality of planets 409 and the output ring assembly 411B is drivingly engaged to the plurality of planets 409; a first carrier 412A coupled to the main shaft 418 through a first carrier bearing 413A, a second carrier 412B coupled to the main shaft 418 through a second carrier bearing 413B, wherein the plurality of tiltable planets 409 are coupled to the first and second carriers 412A, 412B through the axles 420; and an idler assembly 410 supporting the tiltable planets 409 comprising; a first idler 401A, a second idler 401B, an idler thrust bearing 402, a first idler support bearing 430a comprising; a first bearing race 405a, a first preload device 406a acting on the first bearing race 405a and a third bearing race 438a, a second idler support bearing 430b comprising; a second bearing race 405b, a second preload device 406b acting on the second bearing race 405b and a fourth bearing race 438b; a plurality of bearing balls 425 in the first bearing race 405a and the second bearing race 405b, wherein the first bearing race 405a and the second bearing race 405b are each a split-bearing race supporting the plurality of bearing balls 425, wherein the third bearing race 438a and the fourth bearing race 438b are each a cylindrical bearing race in contact with the plurality of bearing balls 425 in the first and second bearing races 405a, 405b respectively, wherein the first and second idler support bearings 430a, 430b are decoupled from the main shaft 418 and grounded between the first carrier 412A and the second carrier 412B to reduce the speed of the first idler support bearing 430a and second idler support bearing 430b.

In some embodiments, the third and fourth cylindrical bearing races 438a, 438b allow axial movement of the idler assembly 410.

In some embodiments, the first and second idler support bearings 405a, 405b comprise radial ball bearings 425 to achieve said axial movement.

In some embodiments, the first and second bearing split races 405a, 405b are each an inner bearing race and the third and fourth cylindrical bearing races 438a, 438b are each an outer bearing race.

In some embodiments, the third and fourth cylindrical bearing races 438a, 438b are grounded to the first and second carriers 412A, 412B respectively.

In some embodiments, the means of grounding the first and second cylindrical bearing races 438a, 438b to the first and second carriers 412A, 412B comprises: a press fit, a pin, a key, a screw, a pocket in a component of one of the carriers or cylindrical bearing races, a protrusion, a weld, a braze and an adhesive.

In some embodiments, the first and second idler support bearings 405a, 405b further comprise a capture sleeve 423 configured to retain the first bearing race 405a and the second bearing race 405b, the plurality of bearing balls 425 in the first bearing race 405a and the second bearing race 405b, and first preload device 406a and the second preload device 406b in place, relative to each other, to create an idler support bearing sub-assembly.

In some embodiments, the capture sleeve 423 further comprises a capture mechanism 408 configured to retain the first bearing race 405a and the second bearing race 405b, the plurality of bearing balls 425 in the first bearing race 405a and the second bearing race 405b, the first preload device 406a and the second preload device 406b in place, relative to each other, within the capture sleeve 423.

In some embodiments, the capture mechanism comprises: a retaining ring, a spacer, a press-fit diameter, a shoulder and a nut.

In some embodiments, the capture sleeve 423 is configured to slide over the main shaft 418, but rotate independently of the main shaft 418.

In some embodiments, the first and second preload devices 406a, 406b act on the first and second bearing split-races 405a, 405b respectively, pushing the bearing balls 425 radially into the third and fourth cylindrical bearing races 438a, 438b.

In some embodiments, the first and second preload devices comprise: a wave spring, a Belleville washer, a disc spring, a coil spring (i.e.: 508), a spacer (i.e.: 517) and an elastomeric material.

In some embodiments, the first and second preload devices maintain zero radial clearance “y” between the radial ball bearings 425 of the first and second ball bearing split-races 405a, 405b and the third and fourth cylindrical bearing race 338a, 338b.

As illustrated in FIG. 7, in some embodiments, the first and second preload devices (i.e.: 700) generate forces that maintain at least three-point contact (a, b, c) between the rails of the bearing split-races 705, the bearing balls 725 and the cylindrical bearing race 703.

In some embodiments, the spacer 717 of the preload device is configured to limit axial travel between the split-races of the bearing 700 in the event of a radial shock, as also illustrated in FIG. 7.

In some embodiments, the first preload device 406a is positioned either: between the first bearing race 405a and the idler thrust bearing 401A, or axially outside of the first bearing race 405a, with the first bearing race 405a between the first preload device 406a and the idler thrust bearing 401A; and wherein the second preload device 406b is positioned either; between the second bearing race 405b and the second idler 401B, or axially outside of the second bearing race 405b, with the second bearing race 405b between the second preload device 406b and the second idler 401B.

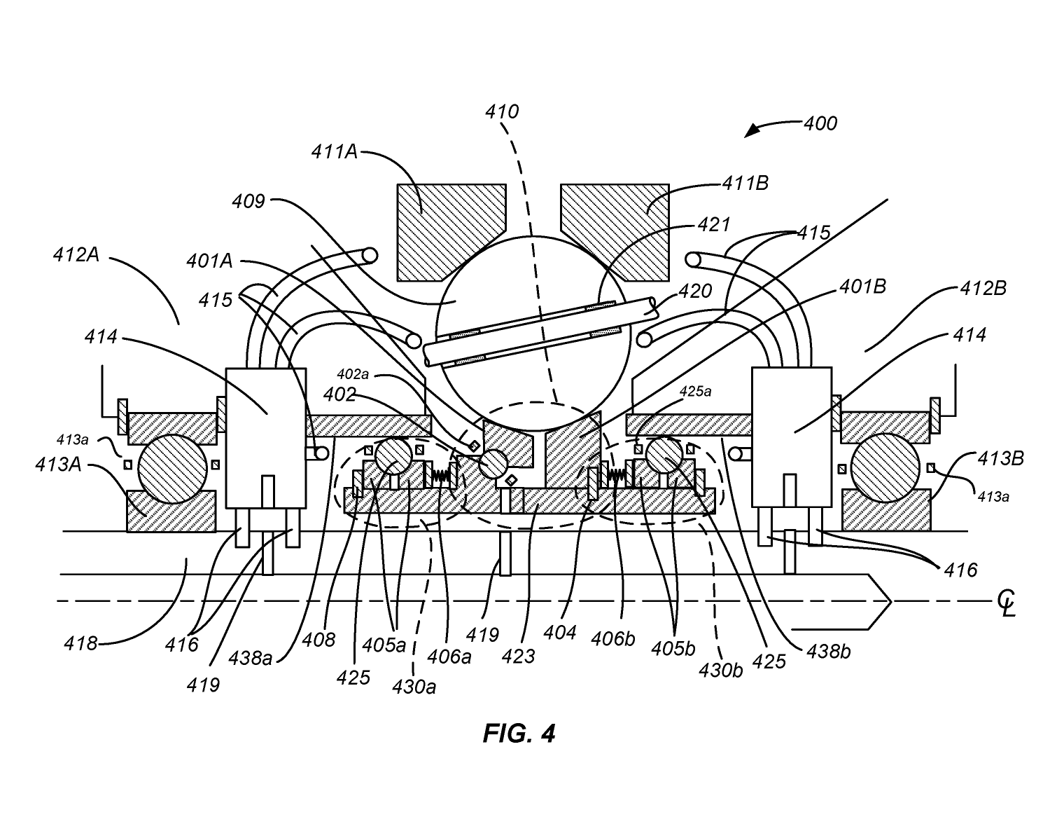

FIG. 4 shows the two preload devices 406a, 406b located inboard, between the idler support bearings 405a, 405b and the idler assembly suns 401A, 401B. Conversely, the two preload devices could be located outboard, between the idler support bearings and the retaining devices.

Provided herein is an idler support bearing 500 for a continuously variable ball planetary variator comprising: a first bearing comprising a first bearing race 505a, a second bearing comprising a second bearing race 505b, a plurality of bearing balls 525 in the first bearing race 405a and the second bearing race 405b, at least one preload device 506 acting on the first bearing race 505a and the second bearing race 505b and at least a third bearing race 503, wherein the first bearing race 505a and the second bearing race 505b are each a split-bearing race supporting the plurality of bearing balls 525, and the at least third bearing race 503 is a cylindrical bearing race in contact with the plurality of bearing balls 525, wherein the at least one preload device 506 limits a worst case radial gap “y” between the plurality of bearing balls 525 supported by the first bearing split-race 505a and the second bearing split-race 505b and the at least third cylindrical bearing race 503.

In some embodiments, the at least one preload device 506 comprises: a wave spring, a Belleville washer, a disc spring, a coil spring 508, a spacer 517 and an elastomeric material.

In some embodiments, the spacer 517 of the at least one preload device 506 is configured to limit axial travel “x” between the split-races of the first and second bearing races 505a, 505b in the event of a radial shock.

In some embodiments, the idler support bearing for a continuously variable ball planetary further comprises a capture sleeve 507 configured to retain the first bearing race 505a and the second bearing race 505b, the plurality of bearing balls 525 in the first bearing race 505a and the second bearing race 505b, and the at least one preload device 506 in place, relative to each other, to create an idler support bearing sub-assembly.

As further illustrated in FIG. 5, the split race bearing assembly 500 with a means to limit radial clearance comprises a main shaft 518, a cylindrical outer bearing race 503, split race bearings 505a and 505b, an array of bearing balls 525, a preload spring 506, a spacer 517 and a carrier sleeve 507. Under normal operating conditions, the spring 506 preloads the split race bearings 505, pushing the bearing balls 525 radially outward into the outer bearing race 503. The radial clearance “y” would be zero and there would be a clearance gap “x” between one of the split races 505 and the spacer 517. In the event of a shock load to the CVP that would drive the balls inward radially, the amount of inward radial displacement of the bearing balls would be proportional to, and limited by, the axial clearance gap “x” distance. The axial clearance gap “x” would be sized such that if the clearance “x” went to zero, the radial clearance “y” between the balls and the races would be some acceptable value (For example: no more than the radial clearance typically found in a radial ball bearing). The spacer (517) limits the radial bearing ball displacement until the spring can recover, forcing the balls back out radially.

In some embodiments, the at least one preload device 506 is positioned either: between the first bearing race 505a and second bearing race 505b, or axially outside of the first bearing race 505a and outside of the second bearing race 505b and within the capture sleeve 507, wherein the races of the first bearing race 505a and second bearing race 505b could be touching each other or abutting a spacer or shoulder therebetween.

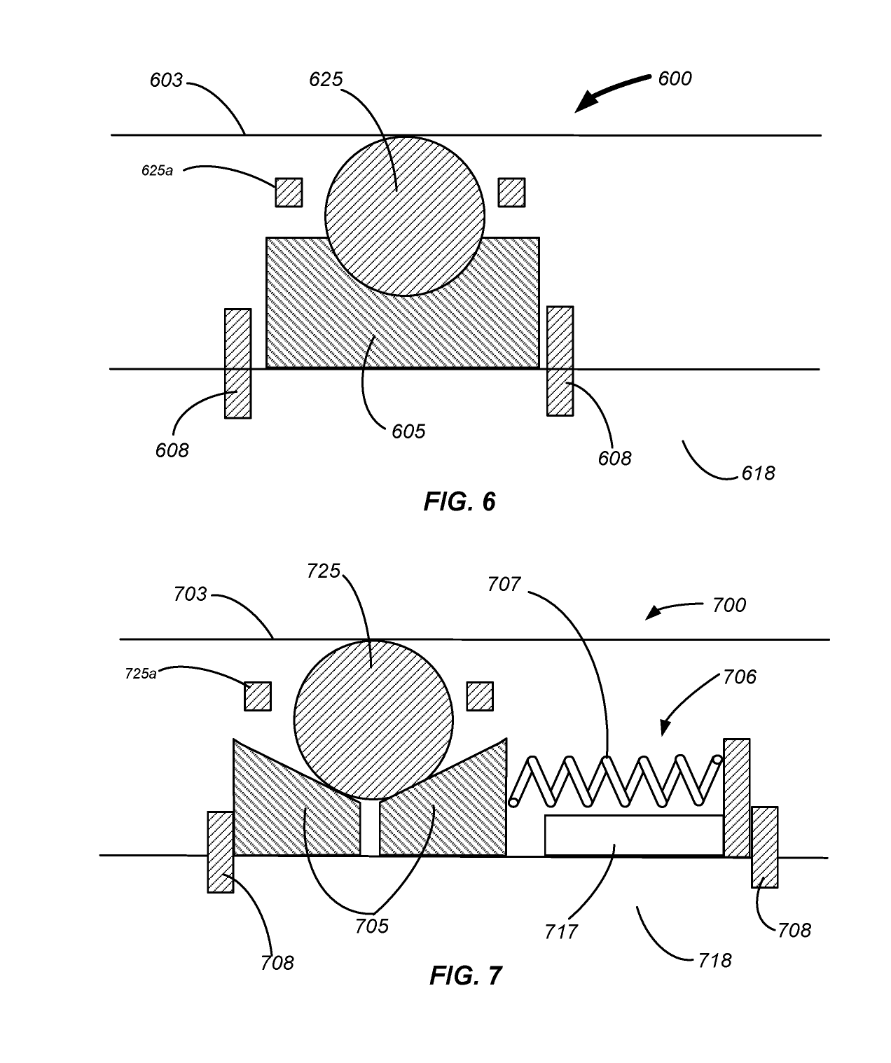

FIG. 6 is an illustrative arrangement of an alternative idler support bearing assembly 600 that could be utilized in a continuously variable ball planetary variator that uses only one grooved bearing race 605 for a similar effect.

Provided herein is an idler support bearing assembly 600 comprising; a first bearing race 605, a second bearing race 603 and a plurality of bearing balls 625, between and in contact with, the first bearing race 605 and the second bearing race 603, wherein the first bearing race 605 is a single grooved bearing race and the second bearing race 603 is a cylindrical bearing race.

In some embodiments, the cylindrical bearing race 603 allows axial movement of the idler assembly.

In some embodiments, the idler support bearing 600 comprises radial ball bearings 625 to achieve said axial movement.

In some embodiments, the standard grooved bearing race 605 is an inner bearing race and the cylindrical bearing race 603 is an outer bearing race.

In some embodiments, the standard grooved bearing race 605 is configured to slide/press over the main shaft 618 for assembly, and rotate with the main shaft 618 during operation.

In some embodiments, idler support bearing assembly 600 further comprises a capture mechanism 608 configured to retain the bearing race 605 in place on the main shaft 618 comprising: a retaining ring 608, a spacer, a press-fit diameter, a shoulder and a nut.

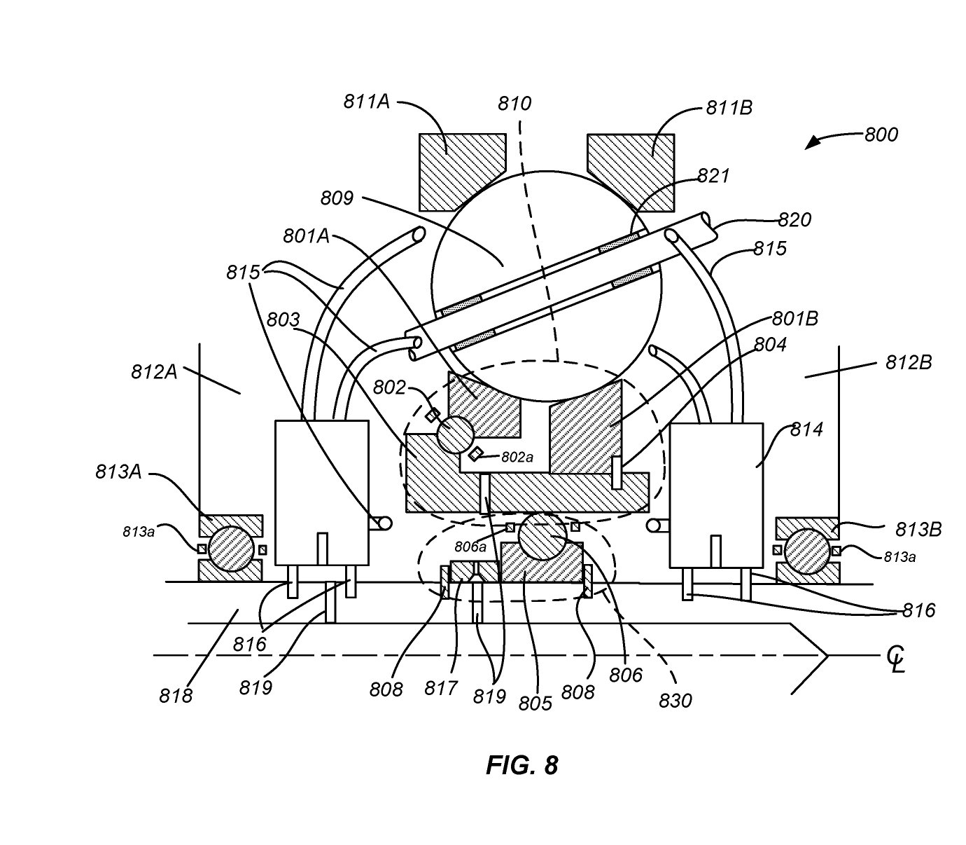

Provided herein is a continuously variable ball planetary variator 800, as illustrated in FIG. 8, comprising a main shaft 818, an input ring assembly 811A, an output ring assembly 811B, a plurality of tiltable planets 809 each comprising an axle 820 therethrough, said axles further comprising a bearing 821 at each end, wherein the input ring assembly 811A is drivingly engaged to the plurality of planets 809 and the output ring assembly 811B is drivingly engaged to the plurality of planets 809; a first carrier 812A coupled to the main shaft 818 through a first carrier bearing 813A; a second carrier 812B coupled to the main shaft 818 through a second carrier bearing 813B; wherein the plurality of tiltable planets 809 are coupled to the first and second carriers 812A and 812B through the axles 820; and an idler assembly 810 supporting the tiltable planets 809 comprising; a first idler 801A, a second idler 801B, an idler thrust bearing 802, an idler support bearing assembly 830 comprising; a bearing comprising a first bearing race 805, a plurality of bearing balls 806, and a second bearing race 803, wherein the first bearing race 805 is a standard grooved bearing race supporting the plurality of bearing balls 806, and the second bearing race 803 is a cylindrical bearing race in contact with the plurality of bearing balls 806.

FIG. 7 is an illustrative arrangement of an alternative idler support bearing assembly 700 that could be utilized in a continuously variable ball planetary variator that uses only one preloaded split race bearing (705) for a similar effect.

Provided herein is an idler support bearing 700 comprising; a first bearing race 705, at least one preload device 706, acting on the first bearing race 705, a second bearing race 703 and a plurality of bearing balls 725, between and in contact with, the first bearing race 705 and the second bearing race 703, wherein the first bearing race 705 is a single split-race and the second bearing race 703 is a cylindrical bearing race.

In some embodiments, the cylindrical bearing race 703 allows axial movement of the idler assembly.

In some embodiments, the idler support bearing 700 comprises radial ball bearings 725 to achieve said axial movement.

In some embodiments, the at least one preload device 706 acts on the split bearing race 705 to form at least one preloaded split bearing race, pushing the bearing balls 725 radially into the cylindrical bearing race 703.

In some embodiments, the at least one preload device 706 comprises: a wave spring, a Belleville washer, a disc spring, a coil spring 707, a spacer 717 and an elastomeric material.

In some embodiments, the at least one preloaded split bearing race maintains zero radial “y” clearance between the radial ball bearings 725 and the cylindrical bearing race 703.

In some embodiments, the at least one preload device 706 generates a force to maintain at least three-point contact (a, b, c) between the rails of the split bearing races 705, the radial ball bearings 725 and the cylindrical race 703.

In some embodiments, the split bearing race 705 is the inner bearing races and the cylindrical bearing race 703 is the outer bearing race.

In some embodiments, the idler support bearing 700 further comprises a capture sleeve 723 configured to retain the bearing with the split-race 705, the plurality of bearing balls 725 and the at least one preload device 706 in place, relative to each other, to form an idler support bearing sub-assembly.

In some embodiments, the idler support bearing sub-assembly 700 is configured to slide and/or press over the main shaft 718 for assembly and rotate with the main shaft 718.

In some embodiments, the continuously variable ball planetary variator further comprises a capture mechanism 708 configured to retain the idler support bearing sub-assembly 700 in place on the main shaft 718 comprising a retaining ring 708, a spacer, a press-fit diameter, a shoulder and a nut.

In some embodiments, the spacer 717 of the at least one preload device 706 is configured to limit axial travel “x” of the split-races 705 in the event of a radial shock.

In some embodiments, the at least one preload device 706 is positioned either: on only one side of the split bearing race 705, or on both sides of the split bearing race.

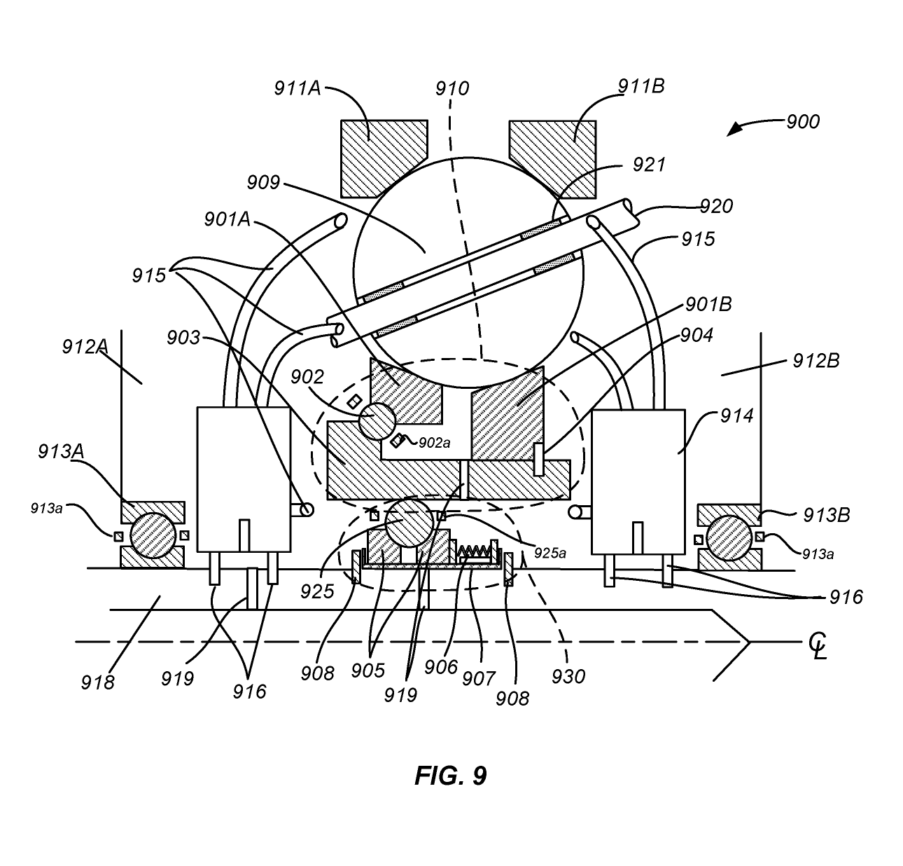

Provided herein is a continuously variable ball planetary variator 900 as illustrated in FIG. 9, comprising: a main shaft 918, an input ring assembly 911A, an output ring assembly 911B, a plurality of tiltable planets 909 each comprising an axle 920 therethrough, said axles further comprising a bearing 921 at each end, wherein the input ring assembly 911A is drivingly engaged to the plurality of planets 909 and the output ring assembly 911B is drivingly engaged to the plurality of planets 909, a first carrier 912A coupled to the main shaft 918 through a first carrier bearing 913A, a second carrier 912B coupled to the main shaft 918 through a second carrier bearing 913B, wherein the plurality of tiltable planets 909 are coupled to the first and second carriers 912A, 912B through the axles 920, and an idler assembly 910 supporting the tiltable planets 909 comprising; a first idler 901A, a second idler 901B, an idler thrust bearing 902, an idler support bearing assembly 930 comprising; a bearing comprising a first bearing race 905, a plurality of bearing balls 925, at least one preload device 906 acting on the first bearing race 905, and a second bearing race 903, wherein the first bearing race 905 is a split bearing race, supporting the plurality of bearing balls 925, and the second bearing race 903 is a cylindrical bearing race in contact with the plurality of bearing balls 925.

In any one of the configurations described herein, one of skill in the art will recognize standard features illustrated in the figures as common components, but not necessarily described or called out in any detail. Such items may include bearing cages (i.e.: 102a, 106a, 113a, 202a, 213a, 225a, 302a, 313a, 325a, 402a, 413a, 425a, 525a, 625a 725a, 802a, 806a, 813a, 902a, 906a and 913a); various retaining rings (i.e.: 104, 108, 204, 208, 304, 308, 404, 408, 804, 808, 904 and 908). Other common features may include lubrication manifolds (i.e.: 114, 214, 314, 414, 814 and 914); lubrication tubes (i.e.: 115, 215, 315, 415, 815 and 915); rotary seals (i.e.: 116, 216, 316 and 416); and various other lubrication passages (i.e.: 119, 219, 319, 419, 819 and 919).

FIGS. 1, 4, 8 and 9 show the idler support bearing raceways (either the standard grooved raceway or the split raceways) as separate components that must be assembled into place. Likewise, the idler support bearing raceways could be directly integrated (for example: machined into the main shaft) either completely in the case of the standard grooved raceway or partially integrated (one raceway side) in the case of the split raceway.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A continuously variable ball planetary variator comprising:
a main shaft;
an input ring assembly;
an output ring assembly;
a plurality of tiltable planets each comprising an axle therethrough;
wherein the input ring assembly is drivingly engaged to the plurality of planets and the output ring assembly is drivingly engaged to the plurality of planets;
a first carrier coupled to the main shaft through a first carrier bearing;
a second carrier coupled to the main shaft through a second carrier bearing;
wherein the plurality of tiltable planets are coupled to the first and second carriers through the axles; and
an idler assembly supporting the tiltable planets comprising;
a first idler,
a second idler,
an idler thrust bearing,
an idler support bearing comprising;
a first bearing comprising a first bearing race,
a second bearing comprising a second bearing race,
a plurality of bearing balls, and
a third bearing race,
wherein the first bearing race and second bearing race are each a standard grooved bearing race supporting the plurality of bearing balls, and the third bearing race is a cylindrical bearing race in contact with the plurality of bearing balls.

2. The continuously variable ball planetary variator of claim 1, wherein the cylindrical bearing race provides for axial movement of the idler assembly.

3. The continuously variable ball planetary variator of claim 2, wherein the idler support bearing comprises radial ball bearings to achieve said axial movement.

4. The continuously variable ball planetary variator of claim 3, wherein the standard grooved bearing races are inner bearing races and the cylindrical bearing race is an outer bearing race.

5. The continuously variable ball planetary variator of claim 3, wherein the idler support bearing further comprises a capture mechanism configured to retain the two standard grooved bearing races and the bearing balls in place, relative to each other, to create an idler support bearing sub-assembly.

6. The continuously variable ball planetary variator of claim 3, wherein the idler support bearing is configured to slide and/or press over the main shaft for assembly, and rotate with the main shaft.

7. The continuously variable ball planetary variator of claim 5, wherein the capture mechanism comprises:
a retaining ring;
a spacer;
a shoulder;
a press-fit diameter;
a capture sleeve; and
a shoulder nut.

8. The continuously variable ball planetary variator of claim 1, further comprising a spacer between the first bearing race and the second bearing race of the idler support bearing.

9. The continuously variable ball planetary variator of claim 5, further comprising a spacer between the first bearing race and the second bearing race of the idler support bearing.

10. The continuously variable ball planetary variator of claim 6, further comprising a spacer between the first bearing race and the second bearing race of the idler support bearing.

11. A continuously variable ball planetary variator comprising:
a main shaft;
an input ring assembly;
an output ring assembly;
a plurality of tiltable planets each comprising an axle therethrough;
wherein the input ring assembly is drivingly engaged to the plurality of planets and the output ring assembly is drivingly engaged to the plurality of planets;
a first carrier coupled to the main shaft through a first carrier bearing;
a second carrier coupled to the main shaft through a second carrier bearing;
wherein the plurality of tiltable planets are coupled to the first and second carriers through the axles; and
an idler assembly supporting the tiltable planets comprising;
a first idler;
a second idler;
an idler thrust bearing;
an idler support bearing comprising;
a first bearing race,
a second bearing race,
a plurality of bearing balls, between and in contact with, the first bearing race and the second bearing race,
wherein the first bearing race is a standard grooved bearing race and the second bearing race is a cylindrical bearing race.

12. The continuously variable ball planetary variator of claim 11, wherein the cylindrical bearing race provides for axial movement of the idler assembly.

13. The continuously variable ball planetary variator of claim 12, wherein the idler support bearing comprises radial ball bearings to achieve said axial movement.

14. The continuously variable ball planetary variator of claim 11, wherein the standard grooved bearing race is an inner bearing race and the cylindrical bearing race is an outer bearing race.

15. The continuously variable ball planetary variator of claim 14, wherein the standard grooved bearing race is configured to slide or press over the main shaft for assembly, and rotate with the main shaft during operation.

16. The continuously variable ball planetary variator of claim 15, further comprising a capture mechanism configured to retain the bearing race in place on the main shaft comprising:
a retaining ring;
a spacer,
a press-fit diameter;
a shoulder, and
a nut.
